(19) United States
(12) Patent Application Publication
(10) Pub. No.: US 2026/0254208 A1
(43) Pub. Date: Aug. 27, 2026

(54) LAMINATED BUSBAR AND METHOD FOR MANUFACTURING LAMINATED BUSBAR

(71) Applicant: YAZAKI CORPORATION, Tokyo (JP)

(72) Inventors: Koki ADACHI, Shizuoka (JP); Sadaharu OKUDA, Shizuoka (JP); Hikaru SANO, Shizuoka (JP); Masayoshi TAKAYANAGI, Shizuoka (JP); Ryoichi MURATA, Shizuoka (JP); Takaaki YUASA, Shizuoka (JP)

(73) Assignee: YAZAKI CORPORATION, Tokyo (JP)

(21) Appl. No.: 19/532,423

(22) Filed: Feb. 6, 2026

(30) Foreign Application Priority Data
Feb. 25, 2025 (JP) 2025-028147

(51) Int. Cl. H02B 1/20

(52) U.S. Cl. CPC H02B 1/20

(57) ABSTRACT

A laminated busbar in which a plurality of busbars formed in a band shape are laminated along a thickness direction, the laminated busbar includes: bolt insertion holes that communicate the busbars along the thickness direction; filling holes that communicate the busbars along the thickness direction; and a resin covering material that covers the plurality of busbars together. The filling holes are filled with the covering material.

### CROSS-REFERENCE TO RELATED APPLICATIONS

This application is based upon and claims the benefit of priority from prior Japanese patent application No. 2025-028147 filed on February 25, 2025, the entire contents of which are incorporated herein by reference.

### BACKGROUND

### 1. Field of the Invention

The present disclosure relates to a laminated busbar in which a plurality of busbars are laminated and a method for manufacturing a laminated busbar.

### 2. Description of the Related Art

In the related art, a laminated busbar connected to a battery mounted on a vehicle is widely known (for example, see JP2018-181780A). In the laminated busbar disclosed in JP2018-181780A, a plurality of busbars formed in a band shape are laminated along a thickness direction. The laminated busbars are fixed to each other by, for example, heat welding. Bolt insertion holes for connection to a battery are formed in the busbars.

In the laminated busbar of the related art, when heat welding is performed to fix the busbars to each other, the busbars are quenched by the heat welding. Therefore, there is a concern that the stress durability of the busbar is reduced. If the busbars are quenched, when bolts or nuts are fastened to the bolt insertion holes provided in the busbars, the nuts or head portions of the bolts may sink into the busbars, so that the busbars may be cracked or the bolts and the nuts may be loosened. Further, in the laminated busbar of the related art, for each busbar having reduced stress durability, the busbar may be broken or detached due to a stress load caused by a use environment during assembly or after assembly.

### SUMMARY

The present disclosure has been made in view of the above-described circumstances, and an object of the present disclosure is to provide a laminated busbar and a method for manufacturing a laminated busbar in which a decrease in stress durability does not occur in busbars laminated on each other.

In order to achieve the object described above, a laminated busbar according to the present disclosure is characterized as follows.

According to an aspect of the present disclosure, there is provided a laminated busbar in which a plurality of busbars formed in a band shape are laminated along a thickness direction, the laminated busbar including: bolt insertion holes that communicate the busbars along the thickness direction; filling holes that communicate the busbars along the thickness direction; and a resin covering material that covers the plurality of busbars together, in which the filling holes are filled with the covering material.

In order to achieve the object described above, a method for manufacturing a laminated busbar according to the present disclosure is characterized as follows.

According to another aspect of the present disclosure, there is provided a method for manufacturing a laminated busbar in which a plurality of busbars formed in a band shape are laminated along a thickness direction, the method including: boring bolt insertion holes and filling holes at predetermined positions along the thickness direction of a respective one of the busbars; arranging the plurality of the busbars in a mold of a covering material that collectively covers the busbars in a state where the busbars are laminated along the thickness direction such that the bolt insertion holes communicate with each other and the filling holes communicate with each other; and injecting a resin material into the mold to form the covering material, in which when the plurality of the busbars are arranged in the mold, the filling holes are arranged in the mold.

According to the laminated busbar and the method for manufacturing a laminated busbar of the present disclosure, there is an effect that a decrease in stress durability does not occur in busbars laminated on each other.

The present disclosure has been briefly described above. Further, the details of the present disclosure can be clarified by reading modes (hereinafter, referred to as "embodiments") for carrying out the invention described below with reference to the accompanying drawings.

### BRIEF DESCRIPTION OF THE DRAWINGS

The present disclosure will become more fully understood from the detailed description given hereinbelow and the accompanying drawing which is given by way of illustration only, and thus is not limitative of the present disclosure and wherein:

FIG. 1 is a plan view of a laminated busbar according to a first embodiment of the present disclosure.

FIG. 2 is a cross-sectional view of the laminated busbar.

FIGS. 3A and 3B are cross-sectional views showing a method for manufacturing a laminated busbar according to the first embodiment of the present disclosure, FIG. 3A is a cross-sectional view showing a boring step of boring bolt insertion holes and filling holes at predetermined positions along a thickness direction of the busbar, and FIG. 3B is a cross-sectional view showing a laminating step of laminating each busbar along the thickness direction.

FIGS. 4A and 4B are cross-sectional views showing the method for manufacturing a laminated busbar according to the first embodiment of the present disclosure, FIG. 4A is a cross-sectional view showing an arrangement step of arranging each busbar in a mold, and FIG. 4B is a cross-sectional view showing an injection step of injecting a resin material into the mold.

FIG. 5 is a cross-sectional view of a laminated busbar according to a second embodiment of the present disclosure.

FIG. 6 is a cross-sectional view of a laminated busbar according to a third embodiment of the present disclosure.

FIG. 7 is a plan view of a laminated busbar according to a fourth embodiment of the present disclosure.

FIG. 8 is a cross-sectional view of a laminated busbar according to a fourth embodiment.

FIG. 9 is a plan view of a laminated busbar according to a fifth embodiment of the present disclosure.

FIG. 10 is a cross-sectional view of a laminated busbar according to a fifth embodiment.

FIG. 11 is a plan view of a laminated busbar according to a sixth embodiment of the present disclosure.

FIG. 12 is a cross-sectional view of a laminated busbar according to a sixth embodiment.

FIGS. 13A to 13D are cross-sectional views of a laminated busbar showing a modification according to the present disclosure.

### DETAILED DESCRIPTION OF THE INVENTION

Hereinafter, a laminated busbar and a method for manufacturing a laminated busbar according to each embodiment of the present disclosure will be described with reference to the drawings.

### First Embodiment

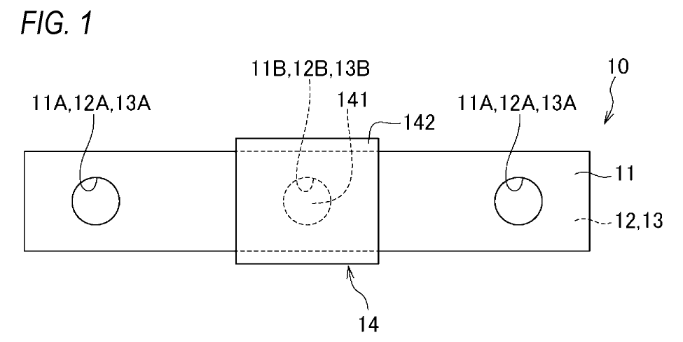

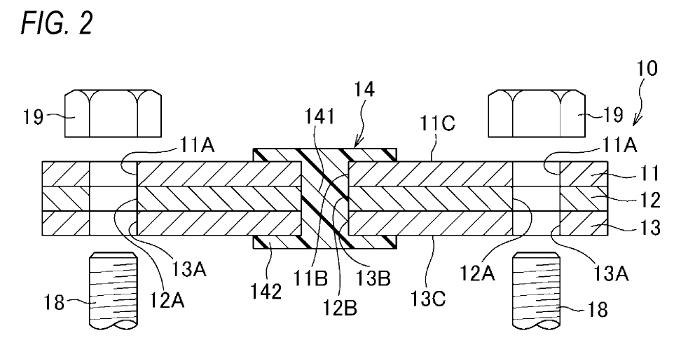

As shown in FIGS. 1 and 2, a laminated busbar 10 has busbars 11, 12, and 13 that are formed in a band shape, and the busbars 11, 12, and 13 are laminated along a thickness direction. The busbars 11, 12, and 13 respectively include bolt insertion holes 11A, 12A, and 13A that are bored along the thickness direction, filling holes 11B, 12B, and 13B that are bored along the thickness direction, and a resin covering material 14 that collectively covers the laminated busbar 10.

The bolt insertion holes 11A, 12A, and 13A have the same opening shape and the same dimension. The bolt insertion holes 11A, 12A, and 13A are provided on both sides of the busbar 11, 12, and 13 in the longitudinal direction. The bolt insertion holes 11A, 12A, and 13A are arranged to communicate with each other when the busbars 11, 12, and 13 are laminated.

The filling holes 11B, 12B, and 13B have the same opening shape and the same dimension. The filling holes 11B, 12B, and 13B are provided at a center of the busbar 11, 12, and 13 in the longitudinal direction. The filling holes 11B, 12B, and 13B are arranged to communicate with each other when the busbars 11, 12, and 13 are laminated.

The covering material 14 includes a filling portion 141 that is formed by filling the filling holes 11B, 12B, and 13B with a resin material, and a covering portion 142 that is continuous with the filling portion 141 and partially covers a face of the laminated busbar 10.

The filling portion 141 is in close contact with inner faces of the filling holes 11B, 12B, and 13B. Accordingly, the busbars 11, 12, and 13 are not separated from each other. The covering portion 142 is made of the same material as the filling portion 141. The covering portion 142 has a substantially rectangular tubular shape that continuously covers faces 11C and 13C of the busbars 11 and 13 and end faces of the busbars 11, 12, and 13. The covering portion 142 is in close contact with the faces 11C and 13C of the busbars 11 and 13 and both end faces of the busbar 11, 12, and 13 in a width direction. Accordingly, the busbars 11, 12, and 13 are not separated from each other.

In the laminated busbar 10 according to the first embodiment, the busbars 11 and 13 are end busbars disposed at end portions in the thickness direction. The busbar 12 is a central busbar sandwiched between the busbars (end busbars) 11 and 13. In the busbars (end busbars) 11, 13, the faces 11C and 13C facing a direction away from the busbar (central busbar) 12 are covered with the covering portion 142 (see FIG. 2).

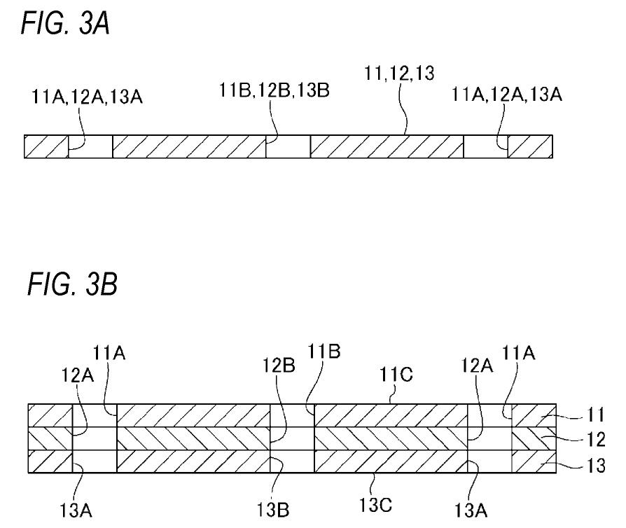

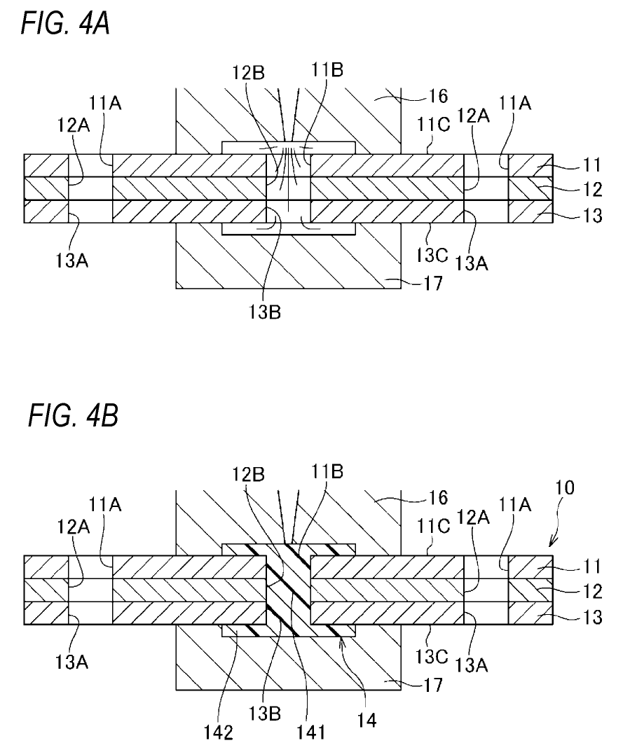

FIGS. 3 and 4 show a method for manufacturing the laminated busbar 10 according to the first embodiment. As shown in FIG. 3A, a boring step of boring the bolt insertion holes 11A, 12A, and 13A and the filling holes 11B, 12B, and 13B at predetermined positions along the thickness direction of a respective one of the busbars 11, 12, 13 is performed. Thereafter, as shown in FIG. 3B, a laminating step of laminating the busbars 11, 12, and 13 along the thickness direction is performed such that the bolt insertion holes 11A, 12A, and 13A communicate with each other and the filling holes 11B, 12B, and 13B communicate with each other.

Next, as shown in FIG. 4A, the busbars 11, 12, and 13 laminated in the laminating step are disposed in a pair of molds 16, 17. At this time, the filling holes 11B, 12B, and 13B are disposed in the pair of molds 16, 17. Thereafter, an injection step of injecting a resin material into each of the molds 16, 17 is performed. By this injection step, the filling holes 11B, 12B, and 13B are filled with the resin material around the busbars 11, 12, and 13, and the filling portion 141 and the covering portion 142 are formed. After the filling portion 141 and the covering portion 142 are solidified, the molds 16, 17 are removed to obtain the laminated busbar 10. In such a laminated busbar 10, a connection bolt 18 erected from the battery is inserted into each of the bolt insertion holes 11A, 12A, and 13A, and then a connection nut 19 is screwed to the connection bolt 18 (see FIG. 2).

### Effects of First Embodiment

As described above, according to the laminated busbar 10 in the first embodiment of the present disclosure, the faces 11C and 13C of the busbars 11, 13 and the end faces of the busbar 11, 12, and 13 are covered with the covering portion 142. That is, the busbars 11, 12, and 13 are collectively covered by the covering portion 142 of the covering material 14. Further, the covering material 14 includes the filling portion 141 that is formed by filling the filling holes 11B, 12B, and 13B with a molten resin material. Therefore, the busbars 11, 12, and 13 are not separated from each other. In addition, according to the laminated busbar 10 in the first embodiment of the present disclosure, it is not necessary to perform heat welding for fixing the busbars 11, 12, and 13 to each other. Therefore, problems in the related art such as sinking of the nut 19, cracks generated in each of the busbars 11, 12, and 13, loosening of the connection bolt 18 and the nut 19 due to application of heat to the busbars 11, 12, and 13, and breakage or detachment of each of the busbars 11, 12, and 13 due to stress load caused by a use environment during assembly or after assembly do not occur.

Further, according to the method for manufacturing laminated busbar in the first embodiment of the present disclosure, since the laminated busbar 10 is manufactured through the boring step, the laminating step, the arrangement step, and the injection step described above, there is no step of performing excessive heat treatment in a manufacturing process, and the laminated busbar 10 in which problems in the related art do not occur can be manufactured.

### Second Embodiment

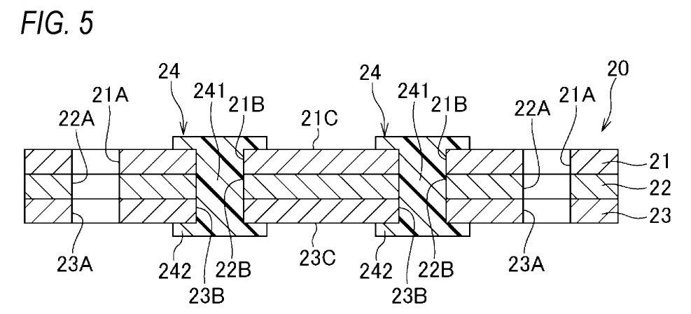

FIG. 5 shows a laminated busbar 20 according to a second embodiment of the present disclosure. In the second embodiment described below, members, portions, names, and the like already described in the first embodiment are denoted by reference numerals corresponding to the reference numerals used in the first embodiment, and description thereof will be simplified or omitted. In the laminated busbar 20, filling holes 21B, 22B, and 23B are provided at two locations at centers of busbars 21, 22, and 23 in the longitudinal direction. In the laminated busbar 20, the covering material 24 are provided at two locations. Similarly to the first embodiment, the covering material 24 includes a filling portion 241 and a covering portion 242.

In the laminated busbar 20 according to the second embodiment, the busbars 21, 23 are end busbars disposed at end portions in the thickness direction. The busbar 22 is a central busbar sandwiched between the busbars (end busbars) 21, 23. In the busbars (end busbars) 21, 23, the faces 21C and 23C facing a direction away from the busbar (central busbar) 22 are covered with the covering portion 242. Both end faces of the busbars 21, 22, and 23 in the width direction are covered with the covering portion 242.

### Effects of Second Embodiment

According to the laminated busbar 20 in the second embodiment of the present disclosure, similarly to the laminated busbar 10 according to the first embodiment described above, the busbars 21, 22, and 23 are not separated from each other by the covering material 24, and various problems in the related art due to heat welding do not occur. According to the laminated busbar 20 in the second embodiment of the present disclosure, since the covering material 24 is provided at two locations, the busbars 21, 22, and 23 can be more firmly fixed to each other as compared with the laminated busbar 10.

### Third Embodiment

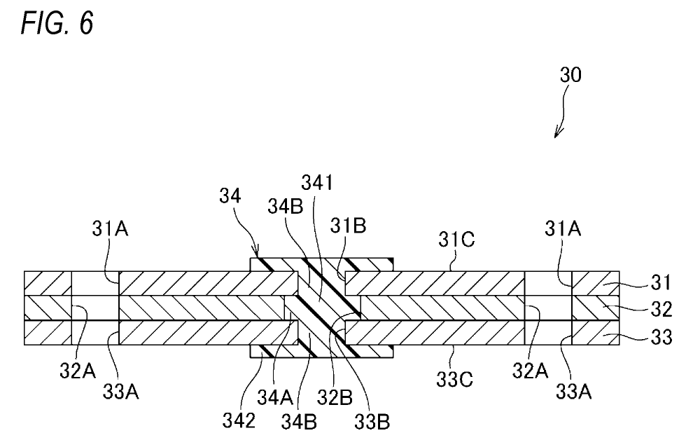

FIG. 6 shows a laminated busbar 30 according to a third embodiment of the present disclosure. In the third embodiment described below, members, portions, names, and the like already described in the first embodiment and the second embodiment are denoted by reference numerals corresponding to the reference numerals used in the first embodiment and the second embodiment, and description thereof will be simplified or omitted.

In the laminated busbar 30, filling holes 31B, 32B, and 33B are provided at centers of busbars 31, 32, and 33 in the longitudinal direction. An inner diameter dimension φ1 of each of the filling holes 31B and 33B is smaller than an inner diameter dimension φ2 of the filling hole 32B, and the filling holes 31B, 32B, and 33B are coaxially disposed. Therefore, in the filling portion 341, a large-diameter portion 34A is provided at an axial center portion, and small-diameter portions 34B and 34B are provided with the large-diameter portion 34A interposed therebetween.

In the laminated busbar 30 according to the third embodiment, the busbars 31, 33 are end busbars disposed at end portions in the thickness direction. The busbar 32 is a central busbar sandwiched between the busbars (end busbars) 31, 33. In the busbars (end busbars) 31, 33, faces 31C and 33C facing a direction away from the busbar (central busbar) 32 are covered with a covering portion 342. Both end faces of the busbars 31, 32, and 33 in the width direction are covered with the covering portion 342.

### Effects of Third Embodiment

According to the laminated busbar 30 in the third embodiment of the present disclosure, similarly to the laminated busbars 10, 20 according to the first embodiment and the second embodiment described above, the busbars 31, 32, and 33 are not separated from each other by a covering material 34, and various problems in the related art due to heat welding do not occur. In the laminated busbar 30 according to the third embodiment of the present disclosure, the large-diameter portion 34A and the small-diameter portions 34B, 34B are provided in the covering material 34. Therefore, the busbars 31, 32, and 33 can be more firmly fixed to each other as compared with the laminated busbar 10 according to the first embodiment and the laminated busbar 20 according to the second embodiment.

### Fourth Embodiment

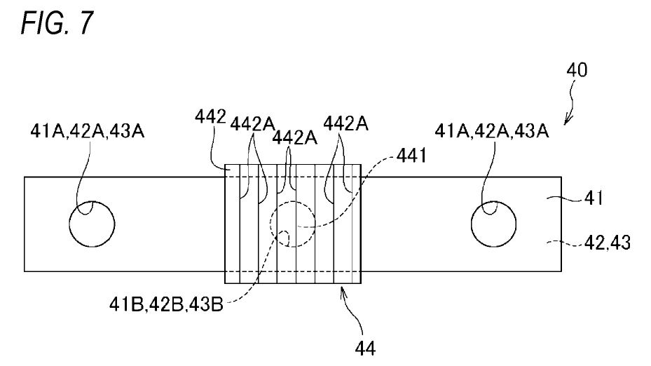

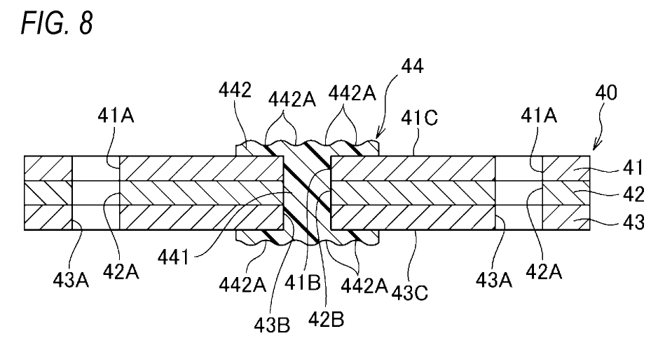

FIGS. 7 and 8 show a laminated busbar 40 according to a fourth embodiment of the present disclosure. In the fourth embodiment described below, members, portions, names, and the like already described in the first embodiment to the third embodiment are denoted by reference numerals corresponding to the reference numerals used in the first embodiment to the third embodiment, and description thereof will be simplified or omitted. The laminated busbar 40 is provided with a plurality of recessed portions 442A on both faces of a covering portion 442 in the thickness direction. These recessed portions 442A are continuous along the width direction (vertical direction in FIG. 7) of the busbars 41, 42, and 43 and are arranged in parallel at predetermined intervals along the longitudinal direction (horizontal direction in FIG. 7) of the busbars 41, 42, and 43. In the laminated busbar 40 according to the fourth embodiment, the busbars 41, 43 are end busbars disposed at end portions in the thickness direction. The busbar 42 is a central busbar sandwiched between the busbars (end busbars) 41, 43. In the busbars (end busbars) 41, 43, faces 41C and 43C facing a direction away from the busbar (central busbar) 42 are covered with the covering portion 442. Both end faces of the busbars 41, 42, and 43 in the width direction are covered with the covering portion 442.

### Effects of Fourth Embodiment

According to the laminated busbar 40 in the fourth embodiment of the present disclosure, similarly to the laminated busbars 10, 20 according to the first embodiment and the second embodiment described above, the busbars 41, 42, and 43 are not separated from each other by a covering material 44, and various problems in the related art due to heat welding do not occur. In the laminated busbar 40 according to the fourth embodiment of the present disclosure, since the recessed portions 442A are provided on the faces of the covering portion 442, flexibility is obtained in the covering portion 442. Therefore, according to the laminated busbar 40 in the fourth embodiment of the present disclosure, even when the busbars 41, 42, and 43 is curved or bent, for example, when there is a height difference or an angle difference between seating surfaces of the pair of connection bolts 18 (see FIG. 2) respectively inserted into left and right bolt insertion holes 41A, 42A, and 43A (left and right in FIG. 8), the covering material 44 is deformed and follows the bending, and the busbars 41, 42, and 43 can be fixed to each other.

Further, in the laminated busbar 40 according to the fourth embodiment of the present disclosure, since the plurality of recessed portions 442A are arranged in parallel, it is possible to flexibly follow the curvature or bending of the busbars 41, 42, and 43.

### Fifth Embodiment

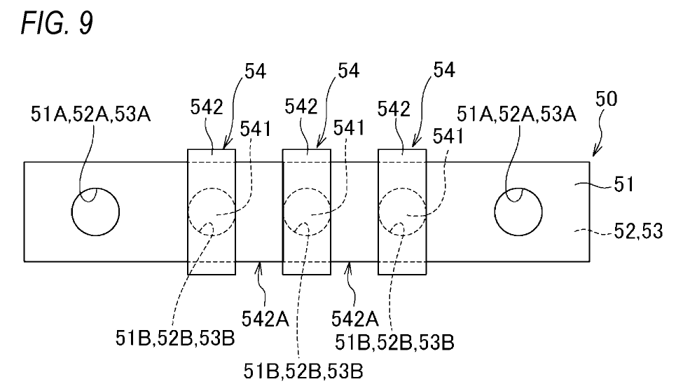

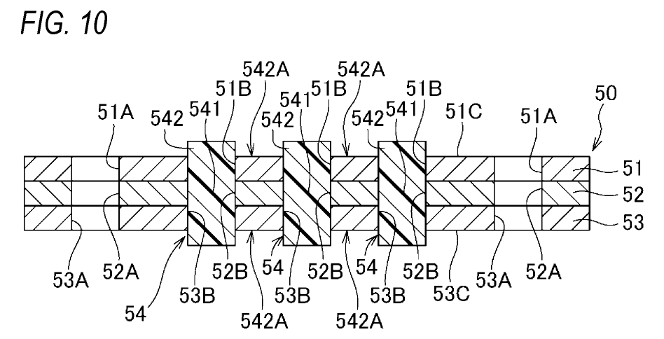

FIGS. 9 and 10 show a laminated busbar 50 according to a fifth embodiment of the present disclosure. In the fifth embodiment described below, members, portions, names, and the like already described in the first embodiment to the fourth embodiment are denoted by reference numerals corresponding to the reference numerals used in the first embodiment to the fourth embodiment, and description thereof will be simplified or omitted. In the laminated busbar 50, filling holes 51B, 52B, and 53B are provided at three locations at centers of busbars 51, 52, and 53 in the longitudinal direction. In the laminated busbar 50, covering materials 54 are provided at three locations. Covering portions 542 are formed such that a dimension of each covering portion 542 along the longitudinal direction of the busbars 51, 52, and 53 is substantially equal to a diameter dimension of each of filling portions 541. These covering portions 542 are recessed portions 542A between which faces 51C and 53C are exposed. These recessed portions 542A are arranged in parallel along the longitudinal direction of the busbars 51, 52, and 53.

In the laminated busbar 50 according to the fifth embodiment, the busbars 51, 53 are end busbars disposed at end portions in the thickness direction. The busbar 52 is a central busbar sandwiched between the busbars (end busbars) 51, 53. In the busbars (end busbars) 51, 53, the faces 51C and 53C facing a direction away from the busbar (central busbar) 52 are covered with the covering portion 542.

### Effects of Fifth Embodiment

According to the laminated busbar 50 in the fifth embodiment of the present disclosure, similarly to the laminated busbar 40 according to the fourth embodiment described above, the busbars 51, 52, and 53 are not separated from each other by the covering material 54, and various problems in the related art due to heat welding do not occur. According to the laminated busbar 50 in the fifth embodiment of the present disclosure, since the recessed portions 542A are provided, similarly to the laminated busbar 40 according to the fourth embodiment, the busbars 51, 52, and 53 can be fixed to each other without hindering the curvature or bending of the busbars 51, 52, and 53.

Further, in the laminated busbar 50 according to the fifth embodiment of the present disclosure, since a plurality of recessed portions 542A are arranged in parallel, it is possible to flexibly follow the curvature or bending of the busbars 51, 52, and 53.

### Sixth Embodiment

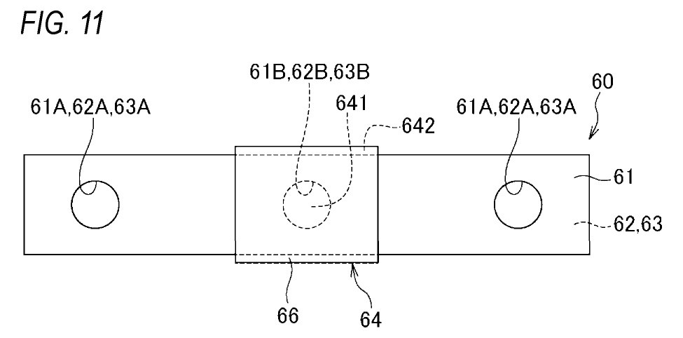

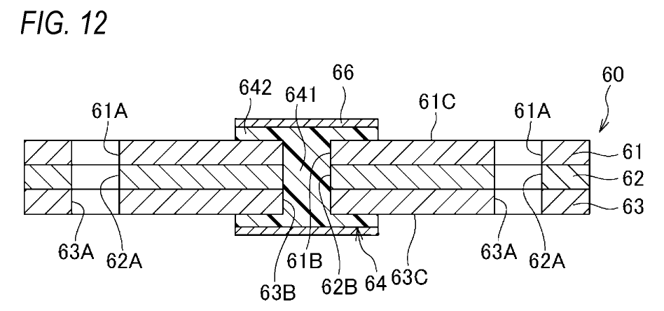

FIGS. 11 and 12 show a laminated busbar 60 according to a sixth embodiment of the present disclosure. In the sixth embodiment described below, members, portions, names, and the like already described in the first embodiment to the fifth embodiment are denoted by reference numerals corresponding to the reference numerals used in the first embodiment to the fifth embodiment, and description thereof will be simplified or omitted. In the laminated busbar 60 according to the sixth embodiment, busbars 61 and 63 are end busbars disposed at end portions in the thickness direction. The busbar 62 is a central busbar sandwiched between the busbars (end busbars) 61 and 63.

In the busbars (end busbars) 61, 63, faces 61C and 63C facing a direction away from the busbar (central busbar) 62 are covered with a covering portion 642. The laminated busbar 60 is provided with conductive layers 66 on both faces (upper face and lower face) of the covering portion 642 in the thickness direction. The conductive layer 66 is made of, for example, nickel (Ni) or tin (Sn). The conductive layer 66 covers the faces of the covering portion 642 by an appropriate method such as sputtering or partial plating.

### Effects of Sixth Embodiment

According to the laminated busbar 60 in the sixth embodiment of the present disclosure, similarly to the laminated busbar 10 according to the first embodiment described above, the busbars 61, 62, and 63 are not separated from each other by the covering material 64, and various problems in the related art due to heat welding do not occur. According to the laminated busbar 60 in the sixth embodiment of the present disclosure, by providing the conductive layers 66 on the upper face and the lower face of the covering portion 642, good shielding properties can be obtained, and the occurrence of noise that adversely affects peripheral devices and the like can be prevented.

### Other Embodiments

The present disclosure is not limited to the embodiments described above, and various modifications can be adopted within the scope of the present disclosure. For example, the present disclosure is not limited to the embodiments described above, and modifications, improvements, and the like can be appropriately made. In addition, materials, shapes, sizes, numbers, arrangement positions, and the like of components in the embodiments described above are freely selected and are not limited as long as the present disclosure can be implemented.

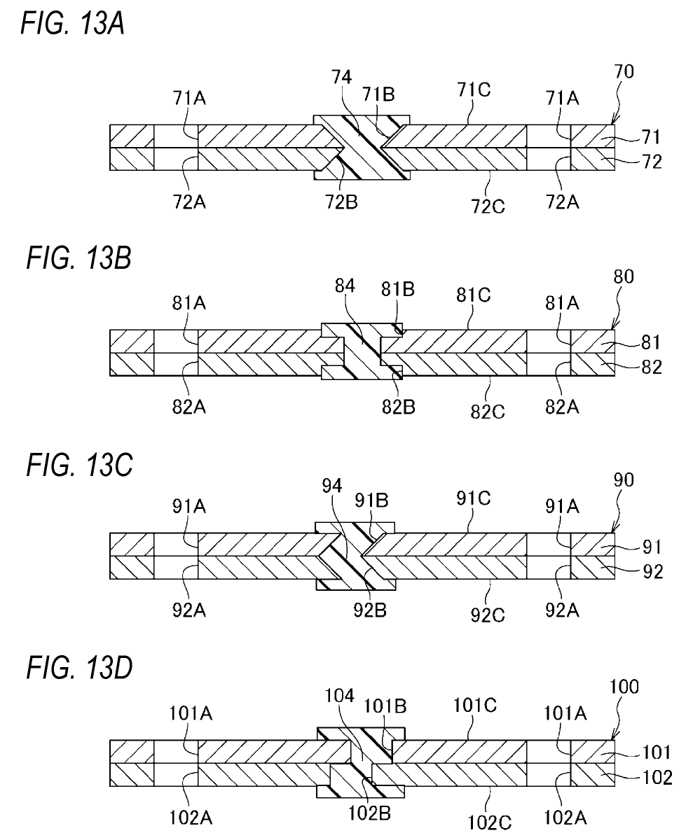

For example, laminated busbars 70, 80, 90, and 100 shown in FIGS. 13A to 13D are also included in the present disclosure. Hereinafter, in the laminated busbars 70, 80, 90, and 100 shown in FIGS. 13A to 13D, members, portions, names, and the like already described in the first embodiment to the sixth embodiment are denoted by reference numerals corresponding to the reference numerals used in the first embodiment to the sixth embodiment, and description thereof will be simplified or omitted.

In the laminated busbar 70 shown in FIG. 13A, filling holes 71B and 72B are tapered holes having a large diameter on front faces 71C and 72C sides. According to, a covering material 74 has a substantially bobbin shape in which an axial center portion has a small diameter.

According to such a laminated busbar 70, similarly to the laminated busbar 10 according to the first embodiment described above, busbars 71, 72 are not separated from each other by the covering material 74, and various problems in the related art due to heat welding do not occur.

In the laminated busbar 80 shown in FIG. 13B, filling holes 81B and 82B are stepped holes having a large diameter on front faces 81C and 82C side. According to such a laminated busbar 80, the same effect as that of the laminated busbar 70 shown in FIG. 13A described above can be obtained.

In the laminated busbar 90 shown in FIG. 13C, filling holes 91B and 92B are provided along directions intersecting a thickness direction and a longitudinal direction of the busbars 91, 92, respectively. According to such a laminated busbar 90, when bolts are inserted into bolt insertion holes 91A and 92A, a direction in which the busbars 91, 92 are separated is restricted to the thickness direction, and thus the busbars 91, 92 can be fixed to each other against a force for separating the busbars 91, 92 along the thickness direction.

In the laminated busbar 100 shown in FIG. 13D, inner diameter dimensions of filling holes 101B and 102B are the same, and axes of the filling holes 101B and 102B are shifted. According to such a laminated busbar 100, busbars 101, 102 can be fixed to each other against a force for separating the busbars 101, 102.

Here, features of the embodiments of the laminated busbar and the method for manufacturing a laminated busbar according to the present disclosure described above are briefly summarized and listed in the following [1] to [6].

[1] A laminated busbar (10) in which a plurality of busbars (11, 12, and 13) formed in a band shape are laminated along a thickness direction, the laminated busbar (10) includes:

bolt insertion holes (11A, 12A, and 13A) that communicate the busbars (11, 12, and 13) along the thickness direction;

filling holes (11B, 12B, and 13B) that communicate the busbars (11, 12, and 13) along the thickness direction; and

a resin covering material (14) that collectively covers the plurality of busbars (11, 12, and 13), in which

the filling holes (11B, 12B, and 13B) are filled with the covering material (14).

According to the laminated busbar (10) having the configuration of [1] described above, the covering material (14) collectively covers the plurality of busbars (11, 12, and 13) and fills the filling holes (11B, 12B, and 13B). Therefore, the busbars (11, 12, and 13) are not separated from each other. In addition, according to the laminated busbar (10), since it is not necessary to perform heat welding to fix the busbars (11, 12, and 13) to each other, problems in the related art such as sinking of the nut (19), cracks generated in each of the busbars (11, 12, and 13), loosening of the connection bolt (18) and the nut (19) due to application of heat to the busbars (11, 12, and 13), and breakage or detachment of each busbar (11, 12, and 13) due to stress load caused by a use environment during assembly or after assembly do not occur.

[2] The laminated busbar (30) according to [1], further includes:

a pair of end busbars (31, 33) that are arranged at both end portions in the thickness direction; and

a central busbar (32) that is sandwiched between the pair of end busbars (31, 33), in which

an inner diameter dimension of each of the filling holes (31B, 33B) in each of the end busbars (31, 33) is smaller than an inner diameter dimension of the filling hole (32B) in the central busbar (32).

According to the laminated busbar (30) of [2] described above, a large-diameter portion (34A) and small-diameter portions (34B, 34B) are provided in the covering material (34) due to a difference in inner diameter dimension of each of the filling holes (31B, 32B, and 33B), and thus the busbars (31, 32, and 33) can be more firmly fixed to each other.

[3] The laminated busbar (40) according to [2], in which

recessed portions (442A) along a width direction of the busbars (41, 43) are provided on both faces of the covering material (44) in the thickness direction.

According to the laminated busbar (40) of [3] described above, since the flexibility of the covering material (44) is obtained by the recessed portions (442A), even when the busbars (41, 42, and 43) are curved or bent, the covering material (44) can be deformed and follow the bending.

[4] The laminated busbar (40) according to [3], in which

a plurality of recessed portions (442A) are provided, and

the recessed portions (442A) are arranged in parallel along a longitudinal direction of the busbars (end busbars) (41, 43).

According to the laminated busbar (10) of [4] described above, since the plurality of recessed portions (442A) are arranged in parallel, it is possible to flexibly follow the curvature or bending of the busbars (41, 42, and 43).

[5] The laminated busbar (60) according to [4], in which

a conductive layer (66) is provided on a face of the covering material (64).

According to the laminated busbar (60) of [5] described above, a good shielding property can be obtained by the conductive layer (66), and the occurrence of noise that adversely affects peripheral devices and the like can be prevented.

[6] A method for manufacturing a laminated busbar (10) in which a plurality of busbars formed in a band shape are laminated along a thickness direction, the method includes:

a boring step of boring bolt insertion holes (11A, 12A, and 13A) and filling holes (11B, 12B, and 13B) at predetermined positions along the thickness direction of a respective one of the busbars (11, 12, and 13);

an arrangement step of arranging a plurality of the busbars (11, 12, and 13) in molds (16, 17) of a covering material (14) that collectively covers the busbars (11, 12, and 13) in a state where the busbars (11, 12, and 13) are laminated along the thickness direction such that the bolt insertion holes (11A, 12A, and 13A) communicate with each other and the filling holes (11B, 12B, and 13B) communicate with each other; and

an injection step of injecting a resin material into the molds (16, 17) to form the covering material (14), in which

in the arrangement step, the filling holes (11B, 12B, and 13B) are arranged in the molds (16, 17).

According to the method for manufacturing the laminated busbar (10) of [6] described above, since the laminated busbar (10) is manufactured through the boring step, the arrangement step, and the injection step, there is no step of performing excessive heat treatment in a manufacturing process, and the laminated busbar (10) in which problems in the related art do not occur can be manufactured.

1. A laminated busbar in which a plurality of busbars formed in a band shape are laminated along a thickness direction, the laminated busbar comprising:
bolt insertion holes that communicate the busbars along the thickness direction;
filling holes that communicate the busbars along the thickness direction; and
a resin covering material that covers the plurality of busbars together, wherein
the filling holes are filled with the covering material.

2. The laminated busbar according to claim 1, further comprises:
a pair of end busbars that are arranged at both end portions in the thickness direction; and
a central busbar that is sandwiched between the pair of end busbars, wherein
an inner diameter dimension of each of the filling holes in each of the end busbars is smaller than an inner diameter dimension of the filling hole in the central busbar.

3. The laminated busbar according to claim 2, wherein
recessed portions along a width direction of the busbar are provided on both faces of the covering material in the thickness direction.

4. The laminated busbar according to claim 3, wherein
the recessed portions are arranged in parallel along a longitudinal direction of the end busbar.

5. The laminated busbar according to claim 1, wherein
a conductive layer is provided on a face of the covering material.

6. A method for manufacturing a laminated busbar in which a plurality of busbars formed in a band shape are laminated along a thickness direction, the method comprising:
boring bolt insertion holes and filling holes at predetermined positions along the thickness direction of a respective one of the busbars;
arranging the plurality of the busbars in a mold of a covering material that collectively covers the busbars in a state where the busbars are laminated along the thickness direction such that the bolt insertion holes communicate with each other and the filling holes communicate with each other; and
injecting a resin material into the mold to form the covering material, wherein
when the plurality of the busbars are arranged in the mold, the filling holes are arranged in the mold.
